(19) United States
(12) Patent Application Publication
(10) Pub. No.: US 2012/0245804 A1
(43) Pub. Date: Sep. 27, 2012

(54) SINGLE-CYLINDER PIN-TYPE TELESCOPIC BOOM TRACK OPTIMIZED CONTROL METHOD AND CONTROL SYSTEM THEREOF

(75) Inventors: Chunxin Zhan, Changsha (CN); Quan Liu, Changsha (CN); Jimei Guo, Changsha (CN); Qifei Hu, Changsha (CN); Yongzan Liu, Changsha (CN); Xinyi Li, Changsha (CN)

(73) Assignees: ZOOMLION HEAVY INDUSTRY SCIENCE AND TECHNOLOGY CO. LTD, CHANGSHA (CN); HUNAN ZOOMLION SPECIAL VEHICLE CO., LTD., Changde (CN)

(21) Appl. No.: 13/498,773

(22) PCT Filed: Sep. 7, 2010
(86) PCT No.: PCT/CN2010/076676

§ 371 Date: Jun. 8, 2012

(30) Foreign Application Priority Data
Sep. 29, 2009 (CN) 200910178572.8

(51) Int. Cl. B66C 13/18

(52) U.S. Cl. 701/50

(57) ABSTRACT

A single-cylinder pin-type telescopic boom track optimized control method and control system thereof are applied to switch between any two working conditions of any sections of a telescopic boom. The method and system establish a constrained condition according to the stroke of a telescopic oil cylinder. When the telescopic boom is changed from the current state A to the target state B, the most rapid and convenient telescopic path can be obtained based on the current position of the pin mechanism and other conditions. The method and system greatly improve the telescopic reliability and work efficiency of the single-cylinder pin-type telescopic boom, and are applied to the telescopic boom of any engineering machine, in particular to the telescopic boom of a heavy duty crane.

The present application claims the priority of Chinese Patent Application No. 200910178572.8, entitled as “Single-Cylinder Pin-Type Telescopic Boom Track Optimized Control Method and Control System Thereof”, and filed with the Chinese Patent Office on Sep. 29, 2009, the contents of which are incorporated herein by reference in its entirety.

### FIELD OF THE INVENTION

The present invention relates to a single-cylinder pin-type telescopic boom control method, in particular to a single-cylinder pin-type telescopic boom track optimized control method.

### BACKGROUND OF THE INVENTION

The telescopic structures of telescopic booms applied in existing engineering machines are available in two types: telescopic hydraulic cylinder and rope set type and single-cylinder pin-type. For a heavy-duty crane with 5 or more sections of booms, only the single-cylinder pin-type structure is applicable, due to the limitation of the structural form.

The working principle of single-cylinder pin-type telescopic mechanism is: a telescopic oil cylinder is mounted in the boom, a pin mechanism is mounted in the head of the telescopic oil cylinder, and a working pin is arranged on the pin mechanism. Each section of boom has bearing pin holes distributed at approx. 0%, 46%, 90%, and 100% positions in length direction and a working pin hole at the tail end; in addition, each section of boom has a bearing pin at the tail end to lock up adjacent sections of boom to each other. When the boom extends or retracts, the telescopic oil cylinder drives the bolt mechanism to the tail of the section j, the telescopic oil cylinder is locked to the section j by extending the working pin, and the bearing pin of the section j inserted into section j−1 is retracted. When the telescopic oil cylinder extends (retracts), the section j moves with the telescopic oil cylinder (extends or retracts); when the target position is reached, the pin mechanism release the bearing pin, so that the section j is locked to the section j−1 relatively, and thereby the extension/retraction action of the section j is accomplished. Repeated in that way, the extension/retraction of each section is accomplished, and thereby the extension/retraction action of the entire boom is accomplished finally.

However, in the process of transition from state A to state B, the existing technical scheme is: the boom is transited from state A to fully retracted state first, and then the sections are extended according to the required target state, to reach to state B. In that way, unnecessary telescopic actions of sections are executed; thus, unnecessary actions of relevant parts including boom slide blocks, telescopic oil cylinder, pin mechanism, and engine happen. Apparently, such a transition approach has a drawback of low extension/retraction efficiency. Especially, in every unnecessary action of pulling out the pin, the pin mechanism bears boom impact as high as tens of tons, and thus the service life of pin mechanism is severely shortened; it is well-known that terrible consequences such as equipment damage and personal injury or death may occur once the pin mechanism fails.

Actually, for a crane with a boom composed of n sections with four bearing pin holes on each section, for example, the boom may have 4ⁿ position states and P(4ⁿ,2) transitions between two states. For example, a telescopic boom composed of five sections may have 4×4×4×4×4=1024 states, that is to say, there are 4⁵!/(4⁵−2)!=1024!/1022!=1047552 switching ways between two states.

In view of above problem, it is urgent task to optimize the track control of existing single-cylinder pin-type telescopic booms, to adapt to the switching between any two states of a boom composed of any number of sections.

### SUMMARY OF THE INVENTION

In view of the drawback described above, the object of the present invention is to provide a single-cylinder pin-type telescopic boom track optimized control method, which determines the optimal sequence of actions of the sections between two states among the numerous switching ways, and thereby obtain the most rapid and convenient telescopic path. On that basis, the present invention further provides a single-cylinder pin-type telescopic boom track optimized control system.

The single-cylinder pin-type telescopic boom track optimized control method provided in the present invention comprises the following steps:

(1) Obtain an initial state array A[a₁, a₂, a₃, aⱼ, . . . , aₙ] and a target state array B[b₁, b₂, b₃, bⱼ, bₙ] of a telescopic boom; wherein, n is the number of sections of the telescopic boom, j is an integer that meets 1≦j≦n, and it represents any section of the telescopic boom; aⱼ and bⱼ are integers between 0˜k−1, respectively, and represent that a section is locked via a bearing pin to one of the k pin holes in the previous section; obtain the section n_code of the telescopic boom where a telescopic mechanism is;

(2) Calculate with the following formula to obtain an intermediate parameter Sₓ, and establish the constrained conditions for stroke of a telescoping cylinder according to the intermediate parameter and physical relationship:

$${S}_{x} = {\sum }_{j}^{x - 1} {a}_{m} + Max ( {a}_{x} , {b}_{x} ) , wherein , x = i , i - 1 , … j + 1 ;$$

(3) Determine whether the constrained conditions are met, and adjust the path vector for each transition from the initial state array to the target state array according to the determination result;

(4) Output a control signal to a pin mechanism and the telescoping cylinder according to the path vector, adjust the coordinated action between the pin mechanism and the telescoping cylinder, so as to control the sequence of actions of the sections in the switching process from the initial state to the target state.

Preferably, in step (2), calculate with the formula to obtain the intermediate parameter Sₓ after the following steps are executed:

(21) set i=n, and set the intermediate variable to zero;

(22) Determine whether aᵢ is equal to bᵢ; if negative, execute step (23);

(23) j=1, obtain the arrays A1 and B1, with the last equal terms eliminated;

In step (3), the path vector is obtained by calculating through the following steps:

(31) Determine whether Sᵢ is greater than 2; if positive, execute step (32);

(32) Determine whether each Sₓ−1 is less than or equal to 2; if positive, execute step (321), and Cj=substitute term j in A1 with Min(1,bⱼ); otherwise execute step (322), and Cj=substitute term j in A1 with 0;

(33) Determine whether Cj is equal to B1; if positive, execute step (34); otherwise set A1=Cj, ggₓ=j, j=j+1, and then return to step (2);

(34) Combine the similar terms in arrays C1, C2, C3, . . . , add and complete the last invariable terms, and then output the result.

Preferably, if the determination result in step (22) is positive, execute step (24) and then return to step (22);

Step (24), set i=i−1.

Preferably, if the determination result in step (31) is negative, execute the following steps:

(40) Set j=1;

(41) Determine whether ggₓ is equal to 0; if positive, execute step (42); otherwise set n_code=ggₓ, and then execute step (42);

(42) Determine whether n_code is smaller than i; if positive, execute step (43); otherwise execute step (45);

(43) Dj=substitute the term n_code in A1 with bₙ_{_{—}}_{code}, and calculate with the following formula to obtain the intermediate parameter Sₓ:

$${S}_{x} = {\sum }_{j}^{x - 1} {a}_{m} + Max ( {a}_{x} , {b}_{x} ) , wherein , x = i , i - 1 , … n\_code ;$$

(44) Determine whether each Sₓ is less than or equal to 2; if negative, execute step (45);

(45) Dj=substitute the term i in A1 with bᵢ, set ggₓ=i;

(46) Determine whether Dj is equal to B1; if positive, execute step (47);

(47) Combine the similar terms in arrays C1, C2, C3, . . . , D1, D2, D3, . . . , add and complete the last invariable terms, and then output the result.

Preferably, if the determination result in step (44) is positive, execute step (51);

(51) Dj=substitute the term n_code in A1 with bₙ_{_{—}}_{code}, set ggₓ=n_code and N=True, and then execute step (46);

Preferably, if the determination result in step (46) is negative, execute the following steps:

(61) Determine whether N is True; if positive, set N=False and then execute step (62); otherwise set i=i−1 and then execute step (62);

(62) Set A1=Dj, j=j+1, Dj=substitute the term i in A1 with bᵢ, ggₓ=i, and then execute step (46).

Preferably, execute step (25) after step (23):

(25) Determine whether only aᵢ is not equal to 0 in A1, if positive, execute step (40); otherwise continue to execute step (2); and Set the minimum value of x to 2 in step (43).

Preferably, execute step (323) after step (321):

(323) Solve Sᵢ from Cj and B1, determine whether Sᵢ is greater than 2; if positive, execute step (322); otherwise execute step (33).

The single-cylinder pin-type telescopic boom track optimized control system provided in the present invention comprises:

an input unit, configured to obtain the initial state array A[a₁, a₂, a₃, . . . aⱼ, . . . , aₙ] and target state array B[b₁, b₂, b₃, . . . , bⱼ, . . . , bₙ] of a telescopic boom; wherein, n is the number of sections of the telescopic boom, j is an integer that meets 1≦j≦n, and it represents any section of the telescopic boom; aⱼ and bⱼ are integers between 0˜k−1, respectively, and represent that a section is locked via a bearing pin to one of the k pin holes in the previous section; obtain the section n_code of telescopic boom where a telescopic mechanism is;

a controller, configured to calculate with the following formula to obtain an intermediate parameter Sₓ, and establish the constrained conditions for stroke of a telescoping cylinder according to the intermediate parameter and physical relationship:

$${S}_{x} = {\sum }_{j}^{x - 1} {a}_{m} + Max ( {a}_{x} , {b}_{x} ) , wherein , x = i , i - 1 , … j + 1 ;$$

determine whether the constrained conditions are met, and adjust the path vector for each transition from the initial state array to the target state array according to the determination result; and

an output unit, configured to output a control signal to a pin mechanism and the telescoping cylinder according to the path vector, adjust the coordinated action between the pin mechanism and the telescoping cylinder, so as to control the sequence of actions of the sections in the switching process from the initial state to the target state.

The single-cylinder pin-type telescopic boom track optimized control method is applicable to switching between any two working states of a telescopic boom composed of any number of sections. The present invention determines the constrained conditions according to the stroke of the telescopic oil cylinder, and can be used to obtain the most rapid and convenient telescopic path on the basis of the current position of the pin mechanism and other conditions, when the telescopic boom transits from the current state A to a target state B. Compared to the prior art, the present invention can greatly improve the telescopic reliability and working efficiency of single-cylinder pin-type telescopic booms.

The single-cylinder pin-type telescopic boom track optimized control method and system thereof provided in the present invention are applicable to the single-cylinder pin-type telescopic booms on any engineering machines, especially telescopic booms on heavy duty cranes.

### BRIEF DESCRIPTION OF THE DRAWINGS

FIG. 1 is a flow chart of an embodiment of the single-cylinder pin-type telescopic boom track optimized control method disclosed in the present invention;

FIG. 2 is a flow chart of another embodiment of the single-cylinder pin-type telescopic boom track optimized control method disclosed in the present invention;

FIG. 3 is a block diagram of the single-cylinder pin-type telescopic boom track optimized control system described in the embodiments of the present invention.

### DETAILED DESCRIPTION OF THE EMBODIMENTS

Based on the existing single-cylinder pin-type telescopic mechanisms, the core of the present invention is to establish a mathematical model, determine the constrained conditions according to the stroke of telescopic oil cylinder, and obtain the most rapid and convenient telescopic path with an optimized method, so as to effectively improve the telescopic reliability and working efficiency of single-cylinder pin-type telescopic booms.

Hereunder the embodiments of the present invention will be detailed, with reference to the accompanying drawings.

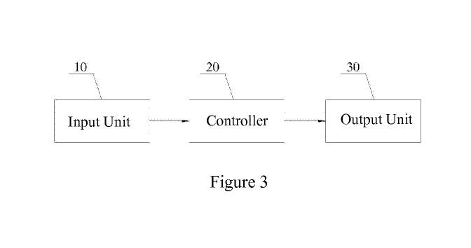

Please refer to FIG. 3, which is a block diagram of the single-cylinder pin-type telescopic boom track optimized control system in the embodiments of the present invention.

The single-cylinder pin-type telescopic boom track optimized control system comprises an input unit 10, a controller 20, and an output unit 30.

wherein, the input unit 10 is configured to obtain the initial state array A[a₁, a₂, a₃, . . . aⱼ, . . . , aₙ] and target state array B[b₁, b₂, b₃, . . . , bⱼ, . . . , bₙ] of a telescopic boom; wherein, n is the number of sections of the telescopic boom, j is an integer that meets 1≦j≦n, and it represents any section of telescopic boom; aⱼ and bⱼ are integers between 0˜k−1, respectively, and represent that a section is locked via a bearing pin to one of the k pin holes in the previous section; obtain the section n_code of telescopic boom where the telescopic mechanism is. It is noted that the layout of bearing pin holes in each section of boom meets the following requirements: the sum of distances between adjacent three holes in any section A+distance between adjacent two holes in any other section B>telescopic stroke of the telescopic oil cylinder. It is understood that at least the distances between the adjacent three holes near the tail of the boom meet above requirements.

Wherein, the controller 20 is configured to calculate with the following formula to obtain an intermediate parameter Sₓ, and establish the constrained conditions for stroke of the telescoping cylinder according to the intermediate parameter and the physical relationship:

$${S}_{x} = {\sum }_{j}^{x - 1} {a}_{m} + Max ( {a}_{x} , {b}_{x} ) , wherein , x = i , i - 1 , … j + 1 ;$$

determine whether the constrained conditions are met, and adjust the path vector for each transition from the initial state array to the target state array according to the determination result.

Wherein, the output unit 30 is configured to output a control signal to the pin mechanism and telescoping cylinder according to the path vector, adjust the coordinated action between the pin mechanism and the telescoping cylinder, so as to control the sequence of actions of the sections in the switching process from the initial state to the target state.

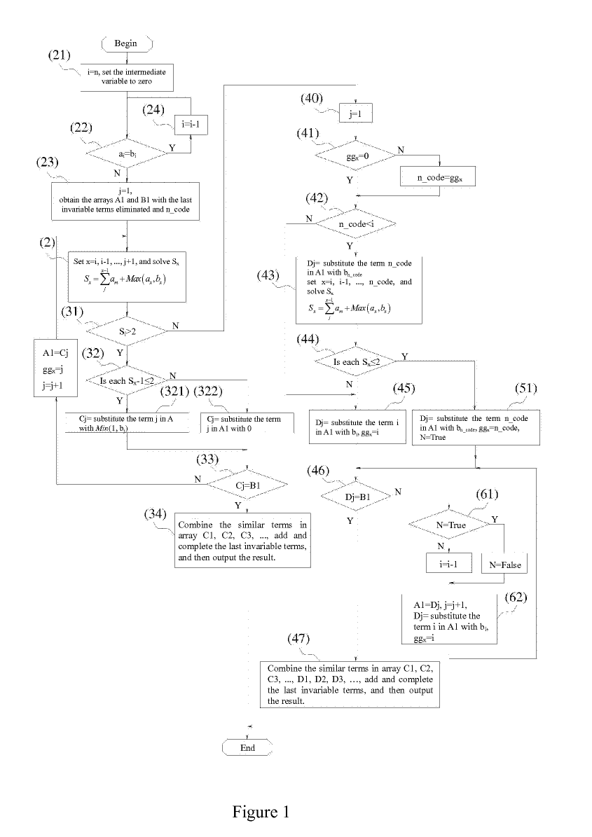

The control method employed by the system is shown in FIG. 1, which is a flow chart of the first embodiment of the optimized control method disclosed in the present invention.

As shown in the Figure, the control method comprises the following steps:

(1) Obtain the initial state array A[a₁, a₂, a₃, . . . aⱼ, . . . , aₙ] and target state array B[b₁, b₂, b₃, . . . , bⱼ, . . . , bₙ] of a telescopic boom; wherein, n is the number of sections of the telescopic boom, j is an integer that meets 1≦j≦n, and it represents any section of telescopic boom; aⱼ and bⱼ are integers between 0˜k−1, respectively, and represent that a section is locked via a bearing pin to one of the k pin holes in the previous section; obtain the section n_code of telescopic boom where the telescopic mechanism is. It is understood that the number of sections of the telescopic boom and the number of pin holes in each section can be arranged freely as required.

(2) Calculate with the following formula to obtain an intermediate parameter Sₓ, and establish the constrained conditions for stroke of the telescoping cylinder according to the intermediate parameter and the physical relationship:

$${S}_{x} = {\sum }_{j}^{x - 1} {a}_{m} + Max ( {a}_{x} , {b}_{x} ) , wherein , x = i , i - 1 , … j + 1 ;$$

(3) Determine whether the constrained conditions are met, and adjust the path vector for each transition from the initial state array to the target state array according to the determination result;

(4) Output a control signal to the pin mechanism and telescoping cylinder according to the path vector, adjust the coordinated action between the pin mechanism and the telescoping cylinder, so as to control the sequence of actions of the sections in the switching process from the initial state to the target state.

Preferably, in step (2), calculate with the formula to obtain the intermediate parameter Sₓ after the following steps are executed:

(21) i=n, set the intermediate variable to zero;

(22) Determine whether aᵢ is equal to bᵢ; if negative, execute step (23);

(23) j=1, obtain the arrays A1 and B1, with the last equal terms eliminated; In step (3), the path vector is obtained by calculating through the following steps:

(31) Determine whether Sᵢ is greater than 2; if positive, execute step (32);

(32) Determine whether each Sₓ−1 is less than or equal to 2; if positive, execute step (321), and Cj=substitute term j in A1 with Min(1, bⱼ); otherwise execute step (322), and Cj=substitute term j in A1 with 0;

(33) Determine whether Cj is equal to B1; if positive, execute step (34); otherwise set A1=Cj, ggₓ=j, j=j+1, and then return to step (2);

(34) Combine the similar terms in arrays C1, C2, C3, . . . , add and complete the last invariable terms, and then output the result.

Preferably, if the determination result in step (22) is positive, execute step (24) and then return to step (22):

Step (24), set i=i−1.

Preferably, if the determination result in step (31) is negative, execute the following steps:

(40) Set j=1;

(41) Determine whether ggₓ is equal to 0; if positive, execute step (42); otherwise set n_code=ggₓ, and then execute step (42);

(42) Determine whether n_code is smaller than i; if positive, execute step (43); otherwise execute step (45);

(43) Dj=substitute the term n_code in A1 with bₙ_{_{—}}_{code}, and calculate with the following formula to obtain the intermediate parameter Sₓ:

$${S}_{x} = {\sum }_{j}^{x - 1} {a}_{m} + Max ( {a}_{x} , {b}_{x} ) , wherein , x = i , i - 1 , … n\_code ;$$

(44) Determine whether each Sₓ is less than or equal to 2; if negative, execute step (45);

(45) Dj=substitute the term i in A1 with bᵢ, set ggₓ=i;

(46) Determine whether Dj is equal to B1; if positive, execute step (47);

(47) Combine the similar terms in arrays C1, C2, C3, . . . , D1, D2, D3, . . . , add and complete the last invariable terms, and then output the result.

Preferably, if the determination result in step (44) is positive, execute step (51):

(51) Dj=substitute the term n_code in A1 with bₙ_{_{—}}_{code}, set ggₓ=n_code and N=True, and then execute step (46);

Preferably, if the determination result in step (46) is negative, execute the following steps:

(61) Determine whether N is True; if positive, set N=False and then execute step (62); otherwise set i=i−1 and then execute step (62);

(62) Set A1=Dj, j=j+1, Dj=substitute the term i in A1 with bᵢ, ggₓ=i, and then execute step (46).

Without loss of generality, hereunder the present invention will be described in an example of a telescopic boom composed of five sections, with four bearing pin holes in each section:

Current state array of boom: A[1, 1, 2,0, 0]

Target state array: B[2,0, 3, 1, 1]

The section where the telescopic mechanism is: n_code=2

1. Step (21): set i=5 (total number of sections), ggₓ=0 (clear the section ggₓ where the telescopic mechanism is in the switching process to zero);

Step (22): a₅=0, b₅=1, and the determination result is negative;

Step (23): Set j=1, since there is no equal term between the current state array of boom A[1,1,2,0,0] and target state array B[2,0,3,1,1], then obtain A1[1,1,2,0,0], B1 [2,0,3,1,1].

Step (2): Set x=5, 4, 3, 2, respectively, and solve S₅, S₄, S₃, and S₂, respectively:

$${S}_{5} = {\sum }_{1}^{4} {a}_{m} + Max ( {a}_{5} , {b}_{5} ) = {a}_{1} + {a}_{2} + {a}_{3} + {a}_{4} + {b}_{5} = 5 ;$$

Likewise, it is calculated that S₄=5; S₃=5, S₂=2;

Step (32): Cj=substitute the term j in A1 with 0, according to the flow chart;

Then: C1=[0,1,2,0,0] - - - ggₓ=1

Step (33): Since C1=[0,1,2,0,0] is not equal to B1[2,0,3,1,1], go back to execute step (2).

2. i=5, j=2, A1=[0,1,2,0,0], B1=[2,0,3,1,1],

i.e., set x=5, 4, 3, and solve S₅, S₄, and S₃, respectively

S₅=4, S₄=4, S₃=4;

Cj=substitute the term j in A1 with 0, according to the flow chart;

Then: C2=[0,0,2,0,0] - - - ggₓ=2

Similarly, since C2=[0,0,2,0,0] is not equal to B1[2,0,3,1,1], go back to execute step (2).

3. i=5, j=3, A1=[0,0,2,0,0], B1=[2,0,3,1,1], i.e., set x=5, 4, and solve S₅ and S₄ respectively;

S₅=3, S₄=3;

Cj=substitute the term j in A1 with Min(1, bⱼ), according to the flow chart;

Then: C3=[0,0,1,0,0] - - - ggₓ=3

It is noted that C3=[0,0,0,0,0] - - - ggₓ=3 if the optimized procedure is not executed;

Similarly, since C3=[0,0,1,0,0] is not equal to B1[2,0,3,1,1], go back to execute step (2).

4. i=5, j=4, A1=[0,0,1,0,0], B1=[2,0,3,1,1], i.e., set x=5, and solve S₅;

S5=2; since S₅ is not greater than 2, execute:

Step (40): Set j=1;

Step (41): Since ggₓ=3 is not equal to 0, then n_code=ggₓ=3;

Step (42): Since n_code=3 is smaller than i;

Then, D1=[0,0,3,0,0] - - - ggₓ=3, and calculate and determine:

i.e., set x=5, 4, 3, and solve S₅, S₄, and S₃, respectively

S₅=4, S₄=4, S₃=3;

Dj=substitute the term i in A1 with bᵢ, ggₓ=i according to the flow chart;

Then: D1=[0,0,1,0,1] - - - ggₓ=5

Step (46): Since D1 is not equal to B1, then execute step (61).

5. i=i−1=4, A1=D1=[0,0,1,0,1], j=j+1=2, B1=[2,0,3,1,1];

Dj=substitute the term i in A1 with bᵢ, ggₓ=i according to the flow chart;

Then: D2=[0,0,1,1,1] - - - ggₓ=4

6. According to the flow chart, i=i−1=3, j=j+1=3, B1=[2,0,3,1,1], A1=D2=[0,0,1,1,1]

Dj=substitute the term i in A1 with bᵢ, ggₓ=i according to the flow chart;

Then: D3=[0,0,3,1,1] - - - ggₓ=3

7. According to the flow chart, i=i−1=2, j=j+1=4, B1=[2,0,3,1,1], A1=D3=[0,0,3,1,1]

Dj=substitute the term i in A1 with bᵢ, ggₓ=i according to the flow chart;

Then: D4=[0,0,3,1,1] - - - ggₓ=2

8. According to the flow chart, i=i−1=1, j=j+1=5, B1=[2,0,3,1,1], A1=D4=[0,0,3,1,1]

Dj=substitute the term i in A1 with bᵢ, ggₓ=i according to the flow chart;

Then: D5=[2,0,3,1,1] - - - ggₓ=1

In conclusion, the telescopic paths are in turn:

C1=[0,1,2,0,0] - - - ggₓ=1

C2=[0,0,2,0,0] - - - ggₓ=2

C3=[0,0,1,0,0] - - - ggₓ=3 (If the optimized procedure is not executed, then C3=[0,0,0,0,0] - - - ggₓ=3)

D1=[0,0,1,0,1] - - - ggₓ=5

D2=[0,0,1,1,1] - - - ggₓ=4

D3=[0,0,3,1,1] - - - ggₓ=3

D4=[0,0,3,1,1] - - - ggₓ=2 - - - Since this term is equal to D3, similar terms are combined.

D5=[2,0,3,1,1] - - - ggₓ=1

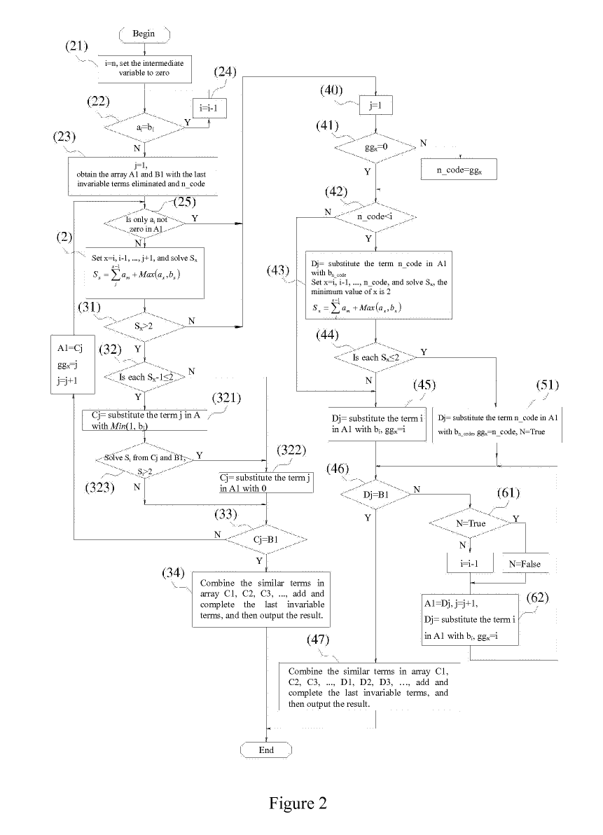

In the present application, another embodiment of the single-cylinder pin-type telescopic boom track optimized control method is also provided. Please see FIG. 2, which is a flow chart of the second embodiment of the single-cylinder pin-type telescopic boom track optimized control method.

As shown in FIG. 1 and FIG. 2, this embodiment is completely the same as the first embodiment in terms of the design concept. The differences lie in:

First, step (25) is executed after step (23):

(25) Determine whether only aᵢ is not equal to 0 in A1, if positive, execute step (40); otherwise continue to execute step (2); and

Set the minimum value of x to 2 in step (43).

Hereunder that design will be described in an example of a telescopic boom composed of five sections, with four bearing pin holes in each section:

Current state array of boom: A[0,0,2,0,0]

Target state array: B[0,0,3,0,0]

The section where the telescopic mechanism is: n_code=1

Total number of section: i=5

1. Step (21): set i=5 (total number of sections), ggₓ=0 (clear the section ggₓ where the telescopic mechanism is in the switching process to zero);

Step (22): a₅=0, b₅=0, and the determination result is positive;

Step (24): set i=i−1=4;

Step (22): a₄=0, b₄=0, and the determination result is positive;

Step (24): set i=i−1=3;

Step (22): a₃=2, b₃=3, and the determination result is negative;

Step (23): Set j=1, since the last two terms are equal between the current state array of boom A[0,0,2,0,0] and target state array B[0,0,3,0,0], then obtain A1[0,0,2], B1[0,0,3].

Step (2): Set x=3, 2, and solve S₃ and S₂, respectively

$${S}_{3} = {\sum }_{1}^{2} {a}_{m} + Max ( {a}_{3} , {b}_{3} ) = {a}_{1} + {a}_{2} + {b}_{3} = 3 ;$$

Similarly, it is calculated as S₂=0;

Step (32): Cj=substitute the term j in A1 with the minimum term of 1 and bⱼ, according to the flow chart;

Then: C1=[0,0,2] - - - ggₓ=1

Step (323), Sᵢ=S₃=3, and the determination result is positive;

Step (322): Substitute the term j in A1 with 0, set j=1, C1=[0,0,2];

Step (33): Since C1=[0,0,2] is not equal to B1[0,0,3], go back to execute step (2).

2. i=3, j=2, A1=[0,0,2], B1=[0,0,3],

i.e., x=3, solve S₃;

S₃=3;

Cj=substitute the term j in A1 with the minimum term of 1 and bⱼ, according to the flow chart; Then: C2=[0,0,2] - - - ggₓ=2

Step (323), Sᵢ=S₃=3, and the determination result is positive;

Step (322): Substitute the term j in A1 with 0, set j=2, C2=[0,0,2];

Similarly, since C2=[0,0,2] is not equal to B1[0,0,3], go back to execute step (2).

3. i=3, j=3, A1=[0,0,2], B1=[0,0,3],

i.e., x=3, solve S₃;

$${S}_{3} = {\sum }_{3}^{2} {a}_{m} + Max ( {a}_{3} , {b}_{3} ) ;$$

Here, strictly speaking, Sₓ can't be calculated normally.

After a determination of step (25) is added in the preferred scheme, step (40) is executed;

Step (40): Set j=1;

Step (41): ggₓ=0 is true;

Step (42): n_code=1, and it is smaller than i;

Then, execute step (43):

D1=[0,0,2], x=3, 2, solve S₃, S₂;

S₃=3, S₂=0

Step (44): S₃ and S₂ are not smaller than 2

Step (45): D1=[0,0,3] - - - ggₓ=3;

Step (46): Since D1 is not equal to B1, then execute step (47).

In conclusion, the telescopic path is:

D1=[0,0,3] - - - ggₓ=3.

Second, step (323) is executed after step (321):

(323) Solve Sᵢ from Cj and B1, determine whether Sᵢ is greater than 2; if positive, execute step (322); otherwise execute step (33).

Hereunder that design will be described in an example of a telescopic boom composed of five sections, with four bearing pin holes in each section:

Current state array of boom: A[0,0,0,1,2]

Target state array: B[2,0,0,1,1]

The section where the telescopic mechanism is: n_code=1

Total number of section: i=5

1. Step (21): set i=5 (total number of sections), ggₓ=0 (clear the section ggₓ where the telescopic mechanism is in the switching process to zero);

Step (22): a₅=2, b₅=1, and the determination result is negative;

Step (23): Set j=1, since there is no equal term between the current state array of boom A[0,0,0,1,2] and target state array B[2,0,0,1,1], then obtain A1[0,0,0,1,2], B1[2,0,0,1,1].

Step (2): Set x=5, 4, 3, 2, respectively, and solve S₅, S₄, S₃, and S₂, respectively

$${S}_{5} = {\sum }_{1}^{4} {a}_{m} + Max ( {a}_{5} , {b}_{5} ) = {a}_{1} + {a}_{2} + {a}_{3} + {a}_{4} + {a}_{5} = 3$$

Likewise, it is calculated that S₄=1; S₃=0, S₂=0;

Since the condition of step (32) is met, Cj=substitute the term j in A1 with Min(1, bⱼ), according to the flow chart;

Then: C1=[1,0,0,1,2] - - - ggₓ=1

In this case, if no determination is added in step (323), then C1[1,0,0,1,2]. Since the last section is 2, it is not in the stroke of the oil cylinder.

In the preferred scheme, a determination is added in step (323) to effectively avoid the above problem. Thus, in this method, step (323) is executed, and then whether the last section is within the telescopic stroke of the oil cylinder is determined according to Cj and B1.

Step (323): Solve S₅=4 according to C1=[1,0,0,1,2] and B1[2,0,0,1,1]; since S₅>2, the condition is determined as true.

Execute step (322), Cj=substitute the term j in A1 with 0, according to the flow chart;

Then: C1=[0,0,0,1,2] - - - ggₓ=1

Step (33): Since C1=[0,0,0,1,2] is not equal to B1[2,0,0,1,1], go back to execute step (25);

Step (25): Determine the condition is not true;

Step (2): i=5, j=2, A1=[0,0,0,1,2], B1=[2,0,0,1,1],

i.e., set x=5, 4, 3, and solve S₅, S₄, and S₃, respectively;

S₅=3, S₄=1, S₃=0;

Execute step (321), Cj=substitute the term j in A1 with Min(1, bⱼ), according to the flow chart;

Then, step (321): C2=[0,0,0,1,2]

Step (323): i=5, j=2, C2=[0,0,0,1,2], B1=[2,0,0,1,1],

i.e., obtain S₅=3;

Cj=substitute the term j in A1 with 0, according to the flow chart;

Then: C2=[0,0,0,1,2] - - - ggₓ=2

Step (33): Since C1=[0,0,0,1,2] is not equal to B1[2,0,0,1,1], go back to execute step (25);

Step (25): Determine the condition is not true;

Step (2): i=5, j=3, A1=[0,0,0,1,2], B1=[2,0,0,1,1],

i.e., set x=5, 4, and solve S₅, and S₄ respectively;

S₅=3, S₄1;

Cj=substitute the term j in A1 with Min(1, bⱼ), according to the flow chart;

Then, step (321): C3=[0,0,0,1,2]

Step (323): i=5, j=3, C3=[0,0,0,1,2], B1=[2,0,0,1,1],

i.e., obtain S₅=3;

Cj=substitute the term j in A1 with 0, according to the flow chart;

Then: C3=[0,0,0,1,2] - - - ggₓ=3

Similarly, since C3=[0,0,0,1,2] is not equal to B1[2,0,0,1,1], go back to execute step (25);

Step (25): Determine the condition is not true;

Step (2): i=5, j=4, A1=[0,0,0,1,2], B1=[2,0,0,1,1],

i.e., set x=5, and obtain S₅=3;

Cj=substitute the term j in A1 with Min(1, bⱼ), according to the flow chart;

Then, step (321): C4=[0,0,0,1,2]

Step (323): i=5, j=4, C4=[0,0,0,1,2], B1=[2,0,0,1,1],

i.e., obtain S₅=3;

Cj=substitute the term j in A1 with 0, according to the flow chart;

Then: C2=[0,0,0,0,2] - - - ggₓ=4

Similarly, since C3=[0,0,0,0,2] is not equal to B1[2,0,0,1,1], go back to execute step (25);

Step (25): Determine the condition is true;

Step (40): Set j=1;

Step (41): ggₓ=4 is not equal to 0, then n_code=ggₓ=4;

Step (42): n_code=4 is smaller than i;

Then, D1=[0,0,0,1,2], B1=[2,0,0,1,1], and n_code=4, and calculate and determine:

i.e., set x=5, 4, and solve S₅, and S₄ respectively;

S₅=3, S₄=1;

Step (44): the condition is not true;

Dj=substitute the term i in A1 with bᵢ, ggₓ=i=5 according to the flow chart;

Then: D1=[0,0,0,0,1] - - - ggₓ=5

Step (46): D1 is not equal to B1, then execute step (61), N=TRUE is not true.

According to the flow chart, i=i−1=4, now, D1=[0,0,0,0,1], j=1, B1=[2,0,0,1,1];

Step (62): A1=D1=[0,0,0,0,1], j=j+1=2, Dj=substitute the term i in A1 with bᵢ, ggₓ=i;

Then: D2=[0,0,0,1,1] - - - ggₓ=4

According to the flow chart, i=i−1=3, now, D2=[0,0,0,1,1], j=2, B1=[2,0,0,1,1];

Step (62): A1=D2=[0,0,0,1,1], j=j+1=3, Dj=substitute the term i in A1 with bᵢ, ggₓ=i;

Then: D3=[0,0,0,1,1] - - - ggₓ=3

According to the flow chart, i=i−1=2, now, D3=[0,0,0,1,1], j=3, B1=[2,0,0,1,1];

Step (62): A1=D3=[0,0,0,1,1], j=j+1=4, Dj=substitute the term i in A1 with bᵢ, ggₓ=i;

Then: D4=[0,0,0,1,1] - - - ggₓ=2

According to the flow chart, i=i−1=1, now, D4=[0,0,0,1,1], j=4, B1=[2,0,0,1,1];

Step (62), A1=D4=[0,0,0,1,1], j=j+1=5, Dj=substitute the term i in A1 with bᵢ, ggₓ=i;

Then: D5=[2,0,0,1,1] - - - ggₓ=1

Step (46): D5=B1

In conclusion, the telescopic paths are:

C1=[0,0,0,1,2] - - - ggₓ=1

C2=[0,0,0,1,2] - - - ggₓ=2

C3=[0,0,0,1,2] - - - ggₓ=3

C4=[0,0,0,0,2] - - - ggₓ=4

D1=[0,0,0,0,1] - - - ggₓ=5

D2=[0,0,0,1,1] - - - ggₓ=4

D3=[0,0,0,1,1] - - - ggₓ=3

D4=[0,0,0,1,1] - - - ggₓ=2

D5=[2,0,0,1,1] - - - ggₓ=1

Combine the similar terms, then:

C4=[0,0,0,0,2] - - - ggₓ=4

D1=[0,0,0,0,1] - - - ggₓ=5 - - - If the optimized procedure is not executed, then
[0,0,0,0,0] - - - ggₓ=5
[0,0,0,0,1] - - - ggₓ=5

D2=[0,0,0,1,1] - - - ggₓ=4

D5=[2,0,0,1,1] - - - ggₓ=1

It seen from the above description of the embodiments: the single-cylinder pin-type telescopic boom track optimized control method is applicable to switching between any two working states of a telescopic boom composed of any number of sections. Compared to the prior art, the method in the present invention determines the constrained conditions according to the stroke of the telescopic oil cylinder, and can be used to obtain the most rapid and convenient telescopic path on the basis of the current position of the pin mechanism and other conditions, when the telescopic boom transits from the current state A to a target state B, and thereby can greatly improve the telescopic reliability and working efficiency of single-cylinder pin-type telescopic booms.

While the present invention has been illustrated and described with reference to some preferred embodiments, the present invention is not limited to these. Those skilled in the art should recognize that various variations and modifications can be made without departing from the spirit and scope of the present invention. For example, a plurality of bearing pin holes other in a number than four bearing pin holes can be arranged in each section. All of such variations and modifications shall be deemed as falling into the protected scope of the present invention.

What is claimed is:

1. A single-cylinder pin-type telescopic boom track optimized control method, comprising the following steps:
(1) obtaining an initial state array A[a₁, a₂, a₃, . . . , aⱼ, . . . , aₙ] and a target state array B[b₁, b₂, b₃, . . . , bⱼ, . . . , bₙ] of a telescopic boom; wherein, n is the number of sections of the telescopic boom, j is an integer that meets 1≦j≦n, and j represents any section of the telescopic boom; aⱼ and bⱼ are integers between 0˜3, respectively, and represent that a section is locked via a bearing pin to one of the four pin holes in the previous section; obtaining the section n_code of the telescopic boom where a telescopic mechanism is;
(2) calculating with the following formula to obtain an intermediate parameter Sₓ, and establishing the constrained conditions for stroke of a telescoping cylinder according to the intermediate parameter and physical relationship:
$${S}_{x} = {\sum }_{j}^{x - 1} {a}_{m} + Max ( {a}_{x} , {b}_{x} ) , wherein , x = i , i - 1 , … j + 1 ;$$
(3) determining whether the constrained conditions are met, and adjusting the path vector for each transition from the initial state array to the target state array according to the determination result; and
(4) outputting a control signal to a pin mechanism and the telescoping cylinder according to the path vector, adjusting the coordinated action between the pin mechanism and the telescoping cylinder, so as to control the sequence of actions of the sections in the switching process from the initial state to the target state.

2. The single-cylinder pin-type telescopic boom track optimized control method according to claim 1, wherein:
in step (2), calculating with the formula to obtain the intermediate parameter Sₓ is performed after the following steps are executed:
(21) setting i=n, and setting the intermediate variable to zero;
(22) determining whether aᵢ is equal to bᵢ; if negative, executing step (23); and
(23) setting j=1, and obtaining the arrays A1 and B1, with the last equal terms eliminated; and
in step (3), the path vector is obtained by calculating through the following steps:
(31) determining whether Sᵢ is greater than 2; if positive, executing step (32);
(32) determining whether each Sₓ−1 is less than or equal to 2; if positive, executing step (321), and obtaining Cj by substituting the term j in A1 with Min(1, bⱼ); otherwise executing step (322), and obtaining Cj by substituting the term j in A1 with 0;
(33) determining whether Cj is equal to B1; if positive, executing step (34); otherwise setting A1=Cj, ggₓ=j and j=j+1, and then returning to step (2); and
(34) combining the similar terms in arrays C1, C2, C3, . . . , adding and completing the last invariable terms, and then outputting the result.

3. The single-cylinder pin-type telescopic boom track optimized control method according to claim 2, wherein, if the determination result in step (22) is positive, then execute step (24) and then return to step (22),
Step (24): setting i=i−1.

4. The single-cylinder pin-type telescopic boom track optimized control method according to claim 3, wherein, if the determination result in step (31) is negative, then execute the following steps:
(40) setting j=1;
(41) determining whether ggₓ is equal to 0; if positive, executing step (42); otherwise setting n_code=ggₓ, and then executing step (42);
(42) determining whether n_code is smaller than i; if positive, executing step (43); otherwise executing step (45);
(43) obtaining Dj by substituting the term n_code in A1 with bₙ_{_{—}}_{code}, and calculating with the following formula to obtain the intermediate parameter Sₓ:
$${S}_{x} = {\sum }_{j}^{x - 1} {a}_{m} + Max ( {a}_{x} , {b}_{x} ) , wherein , x = i , i - 1 , … n\_code ;$$
(44) determining whether each Sₓ is less than or equal to 2; if negative, executing step (45);
(45) obtaining Dj by substituting the term i in A1 with bᵢ, setting ggₓ=i;
(46) determining whether Dj is equal to B1; if positive, executing step (47);
(47) combining the similar terms in arrays C1, C2, C3, . . . , D1, D2, D3, . . . , adding and completing the last invariable terms, and then outputting the result.

5. The single-cylinder pin-type telescopic boom track optimized control method according to claim 4, wherein, if the determination result in step (44) is positive, then execute step (51):
(51) obtaining Dj by substituting the term n_code in A1 with bₙ_{_{—}}_{code}, setting ggₓ=n_code and N=True, and then executing step (46).

6. The single-cylinder pin-type telescopic boom track optimized control method according to claim 5, wherein, if the determination result in step (46) is negative, then execute the following steps:
(61) determining whether N is True; if positive, setting N=False and then executing step (62); otherwise setting i=i−1 and then executing step (62);
(62) setting A1=Dj and j=j+1, obtaining Dj by substituting the term i in A1 with bᵢ, setting ggₓ=i, and then executing step (46).

7. The single-cylinder pin-type telescopic boom track optimized control method according to claim 4 , wherein, step (25) is executed after step (23):
(25) determining whether only a₁ is not equal to 0 in A1, if positive, executing step (40); otherwise continuing to execute step (2); and
setting the minimum value of x to 2 in step (43).

8. The single-cylinder pin-type telescopic boom track optimized control method according to claim 7, wherein, step (323) is executed after step (321):
(323) solving Sᵢ from Cj and B1, determining whether Sᵢ is greater than 2; if positive, executing step (322); otherwise executing step (33).

9. A single-cylinder pin-type telescopic boom track optimized control system, comprising:
an input unit, configured to obtain an initial state array A[a₁, a₂, a₃, . . . , aⱼ, . . . , aₙ] and a target state array B[b₁, b₂, b₃, . . . , bⱼ, . . . , bₙ] of a telescopic boom; wherein, n is the number of sections of the telescopic boom, j is an integer that meets 1≦j≦n, and it represents any section of the telescopic boom; aⱼ and bⱼ are integers between 0˜3, respectively, and represent that a section is locked via a bearing pin to one of the four pin holes in the previous section respectively; obtain the section n_code of the telescopic boom where a telescopic mechanism is;
a controller, configured to calculate with the following formula to obtain an intermediate parameter Sₓ, and establish the constrained conditions for stroke of a telescoping cylinder according to the intermediate parameter and physical relationship:
$${S}_{x} = {\sum }_{j}^{x - 1} {a}_{m} + Max ( {a}_{x} , {b}_{x} ) , wherein , x = i , i - 1 , … j + 1 ;$$
determine whether the constrained conditions are met, and adjust the path vector for each transition from the initial state array to the target state array according to the determination result; and
an output unit, configured to output a control signal to a pin mechanism and the telescoping cylinder according to the path vector, adjust the coordinated action between the pin mechanism and the telescoping cylinder, so as to control the sequence of actions of the sections in the switching process from the initial state to the target state.

10. The single-cylinder pin-type telescopic boom track optimized control method according to claim 5, wherein, step (25) is executed after step (23):
(25) determining whether only aᵢ is not equal to 0 in A1, if positive, executing step (40); otherwise continuing to execute step (2); and
setting the minimum value of x to 2 in step (43).
